(19) United States
(12) Patent Application Publication
(10) Pub. No.: US 2012/0254942 A1
(43) Pub. Date: Oct. 4, 2012

(54) CONNECTION DESTINATION DETERMINATION DEVICE, CONNECTION DESTINATION DETERMINATION METHOD, AND SERVICE COLLABORATION SYSTEM

(75) Inventors: Naoki Hayashi, Yokohama (JP); Tadashi Kaji, Yokohama (JP); Akifumi Yato, Sagamihara (JP); Shinichi Irube, Yokohama (JP)

(73) Assignee: Hitachi, Ltd., Tokyo (JP)

(21) Appl. No.: 13/369,884

(22) Filed: Feb. 9, 2012

(30) Foreign Application Priority Data
Mar. 30, 2011 (JP) 2011-076269

(51) Int. Cl. G06F 21/00

(52) U.S. Cl. 726/3

(57) ABSTRACT

A connection destination determination device includes a control unit for performing an approval determination process to determine that a user authentication state in a connection destination request is approved if the user authentication state satisfies the user authentication state corresponding to a collaboration service. If the user authentication state is determined to be approved in the approval determination process, the control unit responds to a source of the connection destination determination request with the connection destination of service corresponding to the collaboration service which is the search key. If the user authentication state is not determined to be approved in the approval determination process, the control unit responds to the source of the connection destination determination request with the connection destination of authentication service, in order to obtain the user authentication state that does not satisfy the user authentication state corresponding to the collaboration service which is the search key.

### CLAIM OF PRIORITY

The present application claims priority from Japanese application serial no. JP2011-076269, filed on Mar. 30, 2011, the content of which is hereby incorporated by reference into this application.

### FIELD OF THE INVENTION

The present invention relates to a technology for connection destination determination device, connection destination determination method, and service collaboration system.

### BACKGROUND OF THE INVENTION

Distributed computing with Web services has become popular in recent years. The Web Service is a kind of application service using the Simple Object Access Protocol (SOAP) to which the Extensible Markup Language (XML) technology is applied on the Hypertext Transfer Protocol (HTTP) that is the typical protocol for the Web. With the advent of the Next Generation Network (NGN) that provides high reliability and communication quality, the distributed computing with Web services is expected to be used not only in relatively closed network, such as company intranet, as it has been used in the past, but also in open network.

With the proliferation of Web services, the process description language has been developed to configure collaboration services in which a plurality of Web services are involved. Typical examples of the process description language include Web Services Business Process Execution Language (WS-BPEL) defined by the Organization for the Advancement of Structured Information Standards (OASIS), and Business Process Modeling Notation (BPMN) defined by the OMG. Collaboration services are defined by describing the order of the execution of Web services as a scenario by using these process description languages.

When a scenario execution device receives a scenario execution request from a user, the scenario execution device interprets the scenario to sequentially execute Web services, and provides the execution result to the user. It is possible to achieve highly functional collaboration services at a low cost by combining the Web services provided by their own provider and the Web services provided by other providers, as the Web services constituting the collaboration services.

Meanwhile, collaboration services are highly sophisticated and complicated, increasing the number of services involved in the collaboration services. Thus, there is a problem of an increase the process load on the scenario execution device. In order to solve this problem, a technology has been developed to distribute collaboration services to be executed by providing a plurality of scenario execution devices.

For example, according to the technology of U.S. Pat. No. 7,584,276, it is possible to monitor the state of the process load of each scenario device as well as the network load, and to reduce the process volume of the scenario when the process load increases. As a result, the efficiency of the process of the whole system can be increased.

Scenario designers need to accurately and precisely describe the order of services to be called as collaboration services, and the service call condition into a scenario. This requires the scenario designers to know all the services to be called according to the authentication state of the user (registered user after authentication, guest user before authentication), resulting in an increase in development costs and operation costs of the scenario.

### SUMMARY OF THE INVENTION

A principal object of the present invention is to solve the above problems, and achieve collaboration services in which a plurality of Web services are involved at a low cost.

Accordingly, it is an aspect of the present invention to solve the above problems by providing a connection destination determination device used for a service collaboration system. The service collaboration system includes a scenario execution device, a service execution device, and a connection destination determination device. The scenario execution device calls a connection destination service to achieve each of a plurality of collaboration services, based on the scenario that specifies the order of the execution of the collaboration services. The service execution device executes the called connection destination service. The connection destination determination device determines the connection destination service from the collaboration service.

Memory means of the connection destination determination device stores the following data: approval policy data showing a user authentication state for each of the collaboration services in order to allow the collaboration service to be executed; authentication destination list data showing a connection destination of the authentication service to update the user authentication state; and service list data showing a connection destination of service for each of the collaboration services to execute the collaboration service.

A control unit of the connection destination determination device receives a connection destination determination request including the collaboration service, which is a search key, and the user authentication state from the scenario execution device. Then, the control unit performs an approval determination process to determine that the user authentication state of the connection destination request is approved if the user authentication state satisfies the user authentication state corresponding to the collaboration service stored as the search key in the approval policy data. If the user authentication state is determined to be approved in the approval determination process, the control unit obtains the connection destination of service corresponding to the collaboration service, which is the search key, from the service list data. Then, the control unit responds to a source of the connection destination determination request with the obtained connection destination as the connection destination service. On the other hand, if the user authentication state is not determined to be approved in the approval determination process, the control unit obtains the connection destination of authentication service in order to obtain the user authentication state not satisfied in the approval determination process, from the authentication destination list data. Then, the control unit responds to a source of the connection destination determination request with the obtained connection destination as the connection destination service.

Other components will be described below.

According to the present invention, it is possible to achieve collaboration services in which a plurality of Web services are involved at a low cost.

### BRIEF DESCRIPTION OF THE DRAWINGS

FIGS. 1A and 1B are schematic diagrams showing the relationship between a scenario and services, according to an embodiment of the present invention;

FIG. 2 is a block diagram of a service collaboration system according to an embodiment of the present invention;

FIG. 3 is a block diagram of each computer constituting the service collaboration system according to an embodiment of the present invention;

FIG. 4 is a flowchart showing a service collaboration process according to an embodiment of the present invention;

FIG. 5 is a flowchart showing a variation of data handover process in the service collaboration process according to an embodiment of the present invention; and

FIG. 6 is a flowchart showing a connection destination determination process in the service collaboration process according to an embodiment of the present invention.

### DETAILED DESCRIPTION OF THE PREFERRED EMBODIMENT

Hereinafter, an embodiment of the present invention will be described in detail with reference to the accompanying drawings.

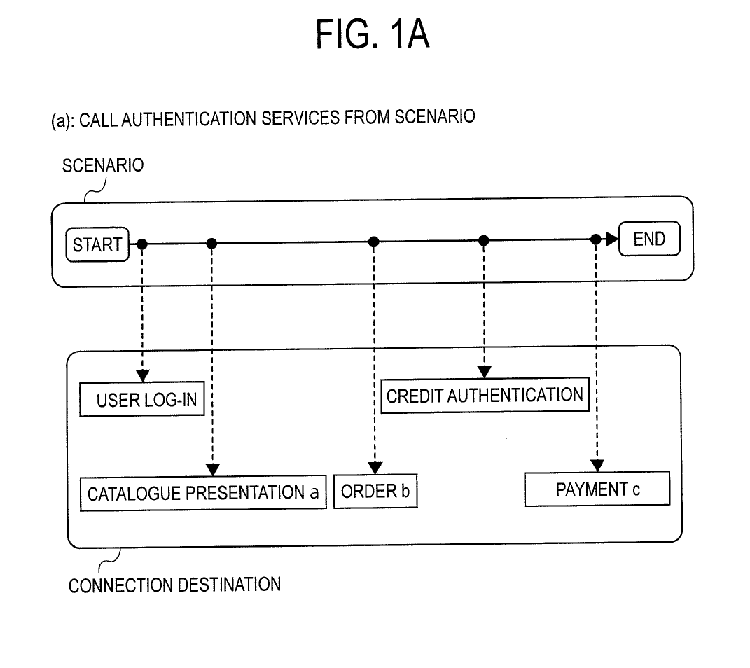

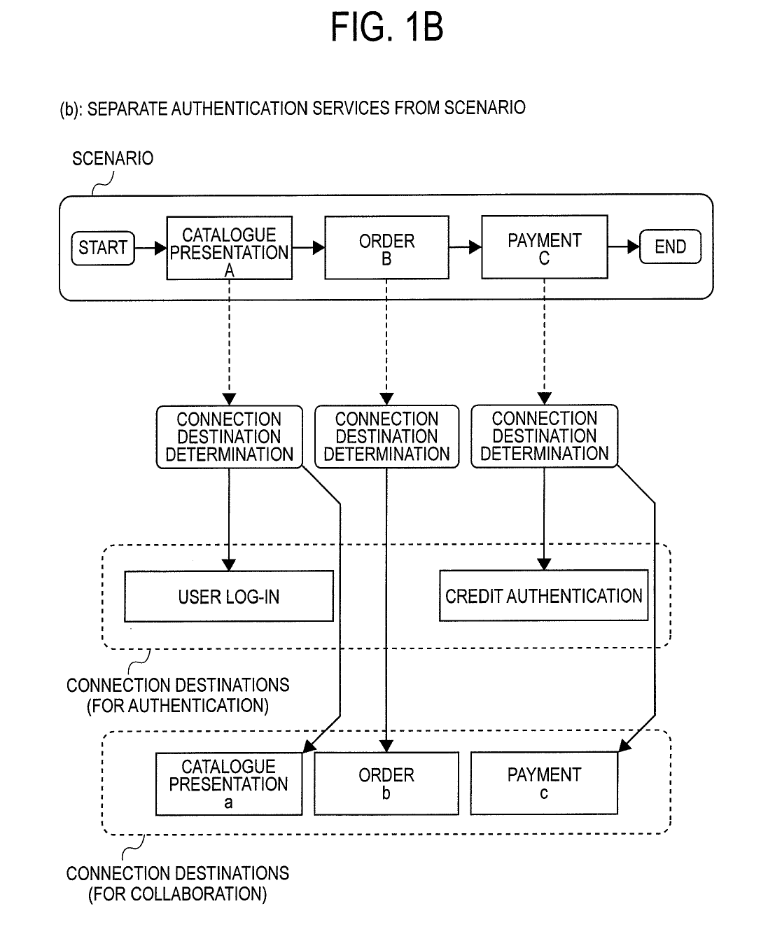

FIGS. 1A and 1B are schematic diagrams showing the relationship between a scenario and services. In the following, the terms used in the description of the present embodiment will be explained with reference to FIGS. 1A and 1B.

As a comparison example, FIG. 1A shows a configuration for calling authentication services from a scenario, for example, in a purchase site.

“Scenario” is a program that defines a series of service calls that starts execution at the point marked “start”, sequentially calls the services (user log-in, and the like) of the connection destination, and complete execution at the point marked “end”.

The services of the connection destination include transaction services relating to product purchase, such as “catalogue presentation a” and “order b”, as well as authentication services necessary for the execution of the transaction services, such as “user log-in” and “credit authentication”.

Thus, the scenario designers need to have knowledge of not only transaction services but also of authentication services. Then, the scenario designers need to design the scenario so as to execute “user log-in” to identify a user and “catalogue presentation a” to recommend selected articles to the identified user, by taking into account the knowledge of both the truncation and authentication services.

In other words, in FIG. 1A, the predetermined Web services are executed only in the order of the predetermined scenario.

FIG. 1B shows a configuration in which “connection destination determination process” is added to the scenario of FIG. 1A, to separate the authentication services from the scenario through the “connection destination determination process”.

According to the “scenario” in FIG. 1B, a process of calling services is performed in the order of “start”, “catalogue presentation A”, “order B”, “payment C”, and “end”. Here, the services such as “catalogue presentation A” described in the scenario represent the types of services to be called (information for service identification), instead of directly showing the services to be called. Hereinafter, the individual services described in the scenario are referred to as “collaboration services”.

The “connection destination determination process” is the process for identifying the service of the connection destination necessary for the execution of the collaboration service, by using the collaboration service name (such as the catalogue presentation A) as the search key. For example, it is necessary to call the transaction service “catalogue presentation a” to execute the collaboration service “catalogue presentation A”. In addition, it is also necessary to call the authentication service “user log-in” as the preparation process. Hereinafter, the transaction services and the authentication services on the end point side to be called are commonly referred to as “connection destination services (or occasionally simply referred to as “connection destinations”)”. The connection destination service is realized, for example, as a Web service using SOAP in a logical interface through which the execution request and the execution result response are transmitted.

A significant feature of this embodiment shown in FIG. 1B is to separately define the collaboration services in the scenario and the connection destination services determined by the connection destination determination process. Because of this feature, the scenario designers can design the scenario by concentrating on the order of processing the transactions, without regard for the authentication services. Further, the designers of the “connection destination determination process” can manage the services by concentrating on the setting in which the connection destination services (the authentication services, the transaction services) are identified from the collaboration services, without regard for the order of processing the collaboration services. In other words, it is possible to clearly distinguish the role of the scenario designers and the role of the designers of the “connection destination determination process”. Thus, the design efficiency (development efficiency) can be improved.

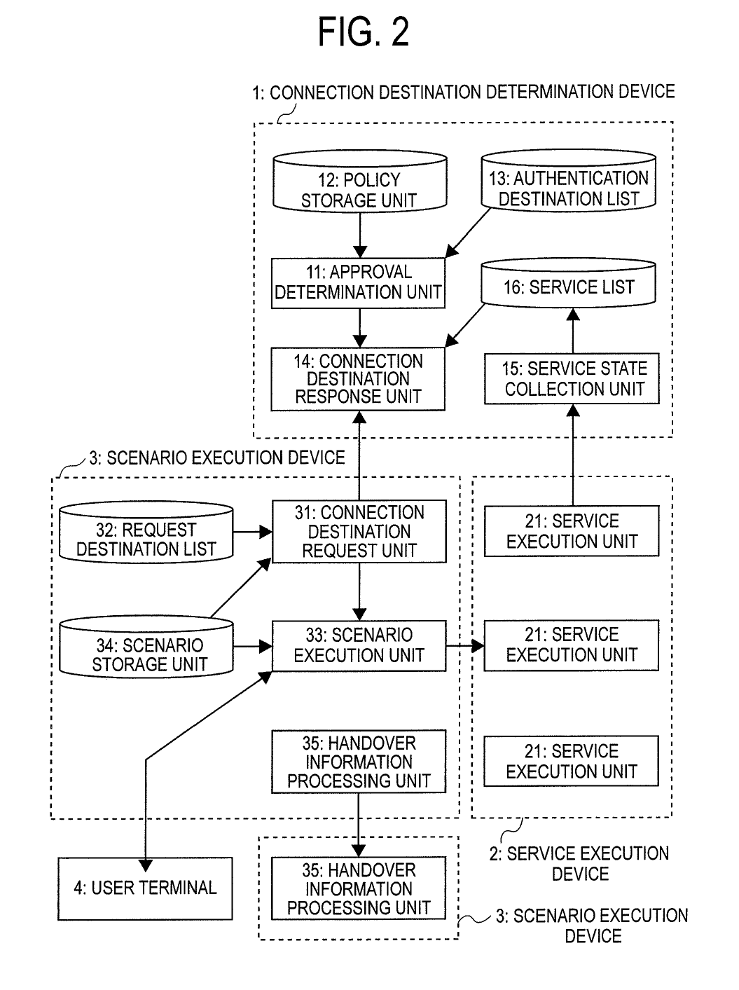

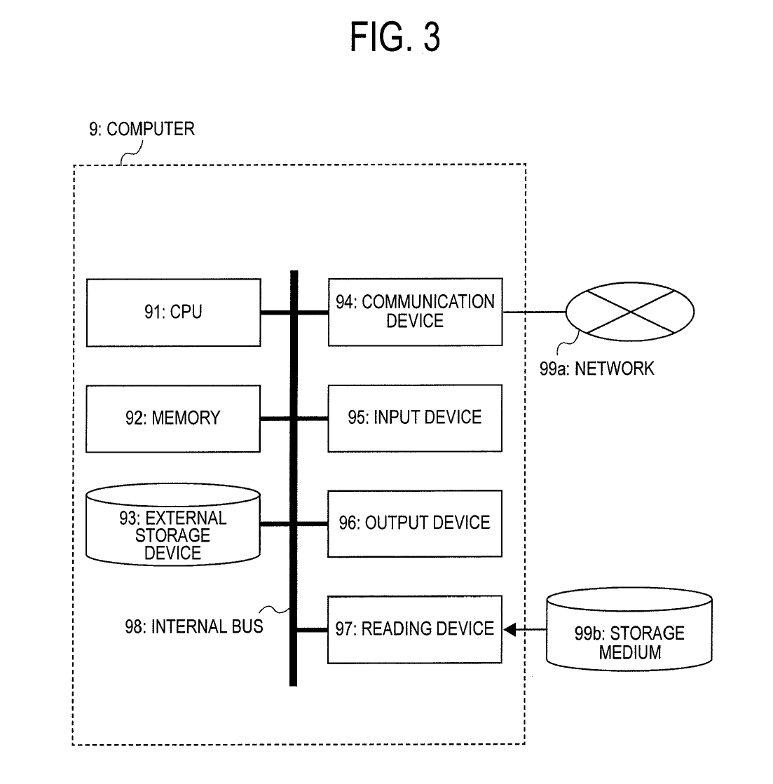

FIG. 2 is a block diagram of a service collaboration system. The service collaboration system includes a connection destination determination device 1, a service execution device 2, a scenario execution device 3, and a user terminal 4, all of which are connected by a network. Each device constituting the service collaboration system is configured as a computer described below with reference to FIG. 3.

The number of units of each device that constitutes the service collaboration system is not limited to the number shown in FIG. 2, and may be one or more than one. A plurality of devices of the same type are configured in a redundant configuration within the service collaboration system, so that when a failure occurs in one of the plurality of devices, the remaining device can continue the process. Thus, the fault tolerance can be improved.

Further, it is shown that the connection destination determination device 1, the service execution device 2, and the scenario execution device 3 are provided as separate components. However, two or more types of the three devices may be housed in one physical computer system. This makes it possible to reduce the setting space of the devices and to reduce the number of wiring cables. As a result, the system can be simplified.

The user terminal 4 transmits to the scenario execution device 3 a request for the execution of the scenario in which the collaboration services are described. Then, the user terminal 4 receives the execution result from the scenario execution device 3.

The scenario execution device 3 executes the scenario in response to the scenario execution request received from the user terminal 4. Then, the scenario execution device 3 requests the service execution device 2 to execute the connection destination services in order to achieve the collaboration services described in the scenario.

The service execution device 2 is a device in which a service execution unit 21 is deployed (or installed) to execute the connection destination services that are requested by the scenario execution device 3. In this embodiment, one or more service execution units 21 are included in one service execution device 2. Note that it is possible to provide a plurality of service execution devices 2 including the service execution unit 21 of the same service content, to distribute the load of the service content in which the load is concentrated.

The connection destination determination device 1 determines the connection destination service as the connection destination to achieve each collaboration service by using the particular collaboration service as the search key, as described in the “connection destination determination process” with reference to FIG. 1B.

The scenario execution device 3 includes a connection destination request unit 31, a scenario storage unit 34, a request destination list 32 (storage unit thereof), a scenario execution unit 33, and a handover information processing unit 35.

The connection destination request unit 31 makes a query to the connection destination determination device 1 (a connection destination response unit 14) with the collaboration service read by the scenario execution unit 33 as the search key, to obtain the connection destination service necessary for the execution of the particular collaboration service. Then, the connection destination request unit 31 notifies the scenario execution unit 33.

The scenario storage unit 34 stores the scenario which is the definition information of the collaboration services to be executed.

The request destination list 32 stores the identification information (such as the URL and IP address) of the connection destination determination device 1 (the connection destination request unit 31) to which the connection destination determination device 1 refers, for each connection destination determination device 1.

The scenario execution unit 33 identifies the collaboration service to be executed, according to the scenario in the scenario storage unit 34. Then, the scenario execution unit 33 requests for the execution of the service to the service execution unit 21 that corresponds to the connection destination service notified by the connection destination request unit 31. Then, the scenario execution unit 33 receives the execution result from the service execution unit 21. Further, when the execution of the collaboration service is completed, the scenario execution unit 33 transmits the execution result of the collaboration service to the user terminal 4 from which the scenario execution request has been transmitted.

In the configuration in which a plurality of scenario execution devices 3 are present, the handover information processing unit 35 is used to establish data linkage with the scenario execution device of the other device by exchanging the memory content (calculation process data) in the scenario execution device 3, as the handover information, with the scenario execution device 3 of the other device. Thus, the handover information processing unit 35 generates the handover information.

Note that in FIG. 2, the components, except for the handover information processing unit 35, are omitted in one of the two scenario execution devices 3, which is shown in the bottom of the figure and also has the same components as the other scenario 3.

The connection destination determination device 1 includes an approval determination unit 11, a policy storage unit 12, an authentication destination list 13 (storage unit thereof), a connection destination response unit 14, a service state collection unit 15, and a service list 16 (storage unit thereof).

The connection destination determination device 1 is configured as a computer including a control unit and a memory unit. The control unit executes the approval determination unit 11, the connection destination response unit 14, and the service state collection unit 15. The memory unit stores the policy storage unit 12, the authentication destination list 13, and the service list 16.

The approval determination unit 11 determines that the client user authentication state is approved if the client user authentication state satisfies the security policy specified for each destination service (transaction service). For example, the client user authentication state means the authentication assertion based on the cookie or Security Assertion Markup Language (SAML) for authentication issued by the identity provider when the client user is authenticated.

The policy storage unit 12 stores the security policy specified for each destination service (transaction service). For example, in FIG. 1B, the security policy means that the transaction service of payment c requires the client user authentication state in which the credit authentication is successful.

The authentication destination list 13 is a list of authentication services that are the connection destination services to be called to obtain the client user authentication state.

Upon receiving the query for the connection destination with the collaboration service as the search key from the connection destination request unit 31, the connection destination response unit 14 determines the connection destination service for the execution of the collaboration service, based on the approval result in the approval determination unit 11 or other information. Then, the connection destination response unit 14 responds to the connection destination request unit 31.

The service state collection unit 15 collects the service state of the service execution unit 21 and writes out to the service list 16.

The service list 16 is a list of the services of the service execution unit 21, in which each service is associated with the information (such as the URL of the connection destination, the service state) relating to the particular service.

TABLE 1
12 Policy storage unit

| Collaboration | |
|---|---|
| service name | Approval policy |
| Web service A | Authentication is not required |
| Web service B | ID/PW (password) authentication, and |
| | PKI (Public Key Infrastructure) |
| | authentication |
| . | . |
| . | . |
| . | . |

13 Authentication destination list

| | Connection | Connection |
|---|---|---|
| Authentication | destination | destination |
| type | (for authentication) | load value |
| ID/PW | http://idpw1/ | 10 |
| authentication | http://idpw2/ | 20 |
| PKI authentication | http://pki | 30 |
| . | . | . |
| . | . | . |
| . | . | . |

16 Service list

| | Scenario | | |
|---|---|---|---|
| | execution | Connection | Connection |
| Collaboration | device URL | destination | destination |
| service name | (IP address) | (for collaboration) | load value |
| Web service A | 192.168.0.1 | http://provider1/wsA-1/ | 10 |
| | | http://provider2/wsA-2/ | 50 |
| | 192.168.0.2 | http://provider3/wsA-3/ | 20 |
| Web service B | 192.168.0.2 | http://provider3/wsB-1/ | 70 |
| . | . | . | . |
| . | . | . | . |
| . | . | . | . |

The Table 1 is a table showing the data content (the policy storage unit 12, the authentication destination list 13, and the service list 16) stored in the connection destination determination device 1.

The policy storage unit 12 stores data corresponding to the collaboration service name, which is the search key, and to the approval policy to receive the particular collaboration service. The data stored in the policy storage unit 12 is used as the policy. For example, “Web service A” can be executed without authentication. On the other hand, “Web service B” requires two types of authentication “ID/PW authentication, PKI authentication”, before the execution of the service. Note that the approval policy may include not only the information indicating the authentication type (PKI authentication, and the like), but also detailed authentication information, for example on the identity provider by which the authentication should be performed.

The authentication destination list 13 stores the connection destination (the URL starting with “http://) of the authentication service for each authentication type specified by the approval policy of the policy storage unit 12, together with the load value for each service execution unit 21 of the connection destination. Note that the parameters used in the calculation of the load value may include the CPU usage rate of each service execution device 2, the number of connections established between the service execution device 2 and the scenario execution device 3, the network delay, and the network bandwidth usage rate.

The service list 16 stores the collaboration service name as the search key, the scenario execution device 3 (hereinafter referred to as “assigned execution device”) for calling the connection destination service to execute the particular collaboration service, the connection destination service to be called by the particular scenario execution device 3, and the load value for each service execution unit 21 of the connection destination.

Although it is shown that only the URL is stored in the “connection destination” column of the authentication destination list 13 and the service list 16, it is also possible to store information for building a logical interface for communication. For example, the information for building a logical interface for communication is described by the Web Services Description Language (WSDL).

Further, with respect to the load value stored in the “connection destination load value” column in the authentication destination list 13 and in the service list 16, the load is large as the value is larger. Thus, the load value is not selected for the distribution of the load. Further, the load of all the destination services may not be stored in the “connection destination load value” as the load value. It is possible to store only the load value to be managed by the own device. When the load value stored in the “connection destination load value” column corresponds to the load of a portion of the connection destination services, it is possible to determine a low-load connection destination service by the following roaming procedures 1 to 4.

It is assumed that a plurality of destination determination devices 1 are referred to as “first destination determination device 1”, “second destination determination device 1”, and so on, in the order of receiving queries for destinations.

Procedure 1: If there is a connection destination service with a low load (which is equal to or less than a predetermined threshold) in the connection destination load values managed by the first destination determination device 1, the low load destination service is used.

Procedure 2: If there is no destination service with a low load in the connection destination load values managed by the first destination determination device 1, roaming is performed in the second connection destination determination device 1, which is the other device, to see if there is a connection destination service with a low load in the load values manages by the second destination determination device 1.

Procedure 3: If there is a connection destination service with a low load in the connection destination load values managed by the second destination determination device 1, the low load destination service is used.

Procedure 4: If there is no connection destination service with a low load in the connection destination load values managed by the second destination determination device 1, roaming is performed in the third destination determination device 1, which is the other device, to see if there is a connection destination determination service of a low load in the load values managed by the third destination determination device 1.

(This process is recursively repeated by changing the connection destination determination device 1).

TABLE 2
32 Request destination list

| | Connection destination |
|---|---|
| Connection destination | determination device URL |
| determination device name | (IP address) |
| SS-1 | 111.111.111.111 |
| SS-2 | 111.111.111.112 |
| SS-3 | 111.111.111.113 |
| . | . |
| . | . |
| . | . |

34 Scenario storage unit

| Scenario name | Scenario content |
|---|---|
| Scenario α | String val0 = input( ) |
| | String val1 = invoke (web service A, va0) |
| | String val2 = invoke (web service B, val0) |
| | String val3 = invoke (web service, val1, val2) |
| | output(val3) |
| . | . |
| . | . |
| . | . |

The Table 2 shows the data (the request destination list 32, the scenario storage unit 34) stored in the scenario execution device 3.

The request destination list 32 stores data corresponding to the device name and the URL for each connection destination determination device 1, as the list of the connection destination determination devices 1 in the service collaboration system.

The scenario storage unit 34 stores information in which one row of the table is defined as one scenario. For example, the scenario a of the Table 2 specifies that the collaboration services of the following five lines, which are the scenario content, are executed in this order.

First line: Receive a character string as an input, and store in the variable val0.

Second line: Store the result of the execution of Web service A with val0 into the variable val1.

Third line: Store the result of the execution of Web service B with val1 into the variable val2.

Fourth line: Store the result of the execution of Web service C with val1 and val2 into the variable val3.

Fifth line: Return val3 as the final result.

Note that the description format of the scenario is not limited to the description format shown in the Table 2, and various types of description format such as BPEL and BPMN can also be used.

FIG. 3 is a block diagram of each computer constituting the service collaboration system.

A computer 9 includes a CPU 91, a memory 92, an external storage device 93 such as a hard disk, a communication device 94 for communicating with other devices through a network 99a such as the Internet or Local Area Network (LAN), an input device 95 such as a keyboard or mouse, an output device 96 such as a monitor or printer, and a reading device 97 for a portable storage medium 99b. Then, all the components are connected by an internal bus 98. Examples of the storage medium 99b are an IC card and a USB memory.

The computer 9 loads a program for realizing the function of each processor shown in FIG. 2 into the memory 92, and executes the program by the CPU 91. The program may be stored in advance in the external storage device 93 of the computer 9, or may be downloaded to the external storage device 93 from the other device through the reading device 97 and the communication device 94 when the program is executed.

Then, the program that is once stored in the external storage device 93 is loaded from the external storage device 93 into the memory, and then executed by the CPU 91. Alternatively, the program is directly loaded on the memory and is executed by the CPU 91 without being stored in the external storage device 93.

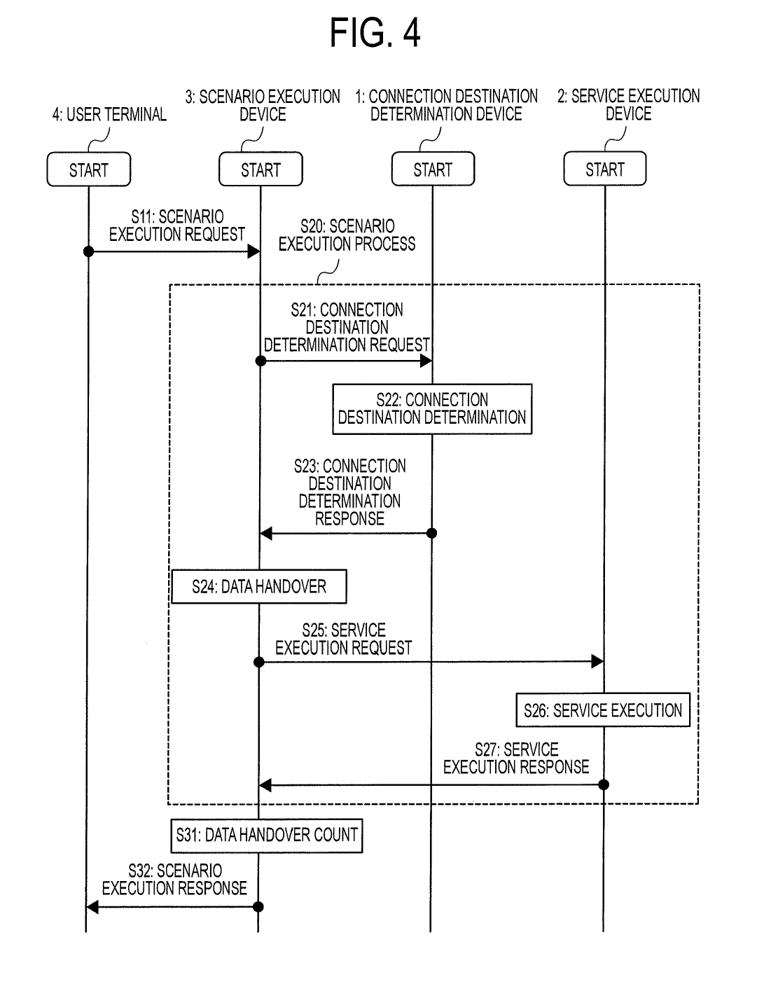

FIG. 4 is a flowchart showing a service collaboration process.

The user terminal 4 receives an operation from a client user, and transmits a scenario execution request to the scenario execution device 3 (S11).

The scenario execution unit 33 executes the scenario specified in the scenario execution request received in S11. In other words, the scenario execution unit 33 executes the process of the steps from S21 to S27, which will be described below, for each collaboration service described in the scenario, as the scenario execution process (S20). Note that, with respect to a plurality of collaboration services (specified by the <FLOW> tag of BPEL, and the like) that can be processed in parallel in the scenario execution process (S20), the process of the steps from S21 to S27 for the plurality of collaboration services can be executed in parallel.

The scenario execution unit 33 transmits a connection destination determination request to the connection destination determination device 1 in order to identify the connection destination service by using the collaboration service as the search key (S21). The connection destination determination request (S21) includes the collaboration service as the search key, as well as the information indicating the client user authentication state.

Note that the scenario execution unit 33 manages the execution progress data (showing how far the execution of the collaboration service has progressed) with respect to the executed scenario. The scenario execution unit 33 compares the executed scenario with the scenario stored in the scenario storage unit 34 to identify the collaboration service to be next executed as the collaboration service which is the search key. For example, in the scenario storage unit 34 of the Table 2, when the (first line) is the execution progress data, the (second line) Web service A is the collaboration service which is the search key.

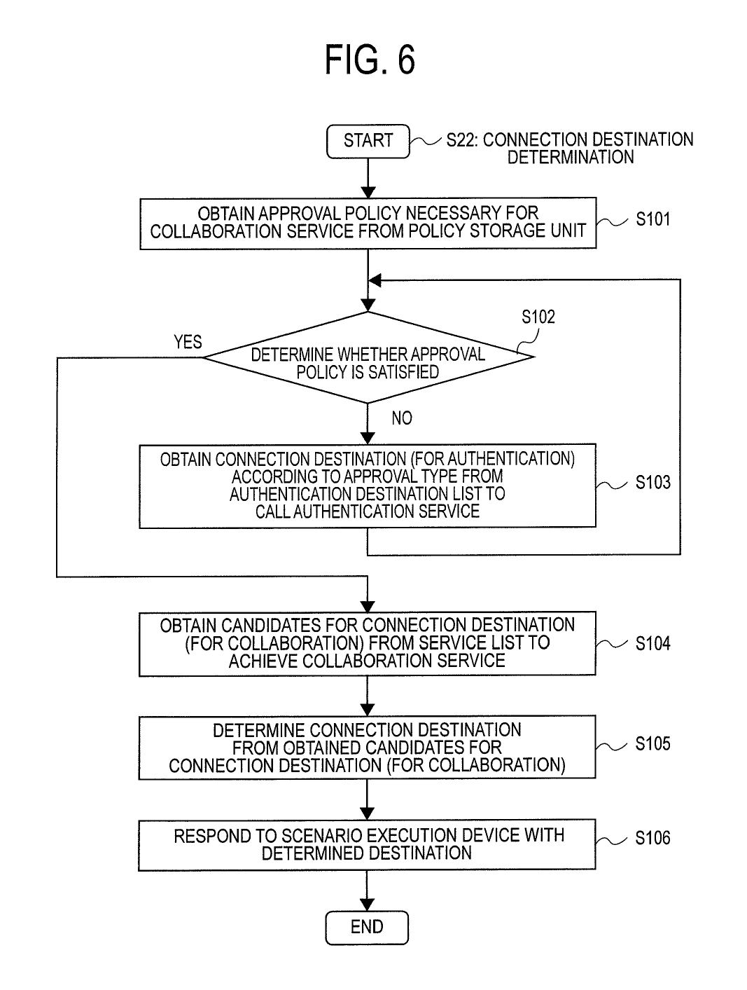

The connection destination response unit 14 receives the connection destination determination request (S21). Then, the connection destination response unit 14 executes a connection destination determination process to identify the connection destination service by using the collaboration service as the search key (S22, see FIG. 6 for the details).

The connection destination response unit 14 responds to the connection destination request unit 31 with the identification information (URL) of the connection destination service determined in S22 as well as the identification information of the scenario execution device 3 which is the execution device of the particular destination service, as the connection destination determination response (S23).

When the execution device assigned to the particular destination service in S23 is the own device, the scenario execution device 3 executes S25, described below, by omitting the process involved in the data handover in S24 and S31 described below.

On the other hand, when the execution device assigned to the particular connection destination service in S23 is another device, the scenario execution device 3 (the handover information processing unit 35) generates handover information as data collaboration (S24), and transmits the handover information to the other scenario execution device 3 corresponding to the assigned execution device. Then, the scenario execution device 3 ends the execution process of the own scenario. Note that the handover information is the information necessary for the execution of the connection destination service, which is a data set stored in the memory of the handover source device. Examples of the data set are as follows.
The identification information of the scenario requested to be executed in S11, and the parameters, such as the address of the requested scenario execution device 3 included in the request of S11
The current execution progress data, namely, the lines that have been completed and the execution result of the services that have been executed
The identification information (URL) of the connection destination service received in S23
The authentication state of the client user

Note that as the connection destination determination response (S23), it is also possible to use a redirect response in which the assigned execution device is specified as the transfer destination. Upon receiving the redirect response, the own scenario execution device 3 can establish a connection to the assigned execution device, which is the other device, to transmit the handover information as data collaboration (S24) by using the connection.

In this way, it is possible to generate the communication channel between the scenario execution devices 3 by only using the HTTP standard library. Thus, there is no need to newly generate a module for generating the corresponding channel.

The scenario execution unit 33 in the assigned execution device transmits a service execution request to the service execution unit 21 shown in the identification information (URL) of the connection destination service in S23 (S25).

The service execution device 2 generates the execution result by executing the corresponding service execution unit 21 according to the service execution request received in S25 (S26). Then, the service execution device 2 responds to the scenario execution unit 33 with the execution result (S27).

The scenario execution device 3 (the handover information processing unit 35) receives the scenario execution request in S11, and completes the scenario execution process of S20 (namely, the process of the steps from S21 to S27). Then, the scenario execution device 3 performs a data handover count process to receive the handover information (the data updated by the service execution in S26) from each scenario execution device 3 (each handover information processing unit 35), which is the other device, to which the data has been handed over in S24 (S31).

Note that the handover information includes the address of the scenario execution device 3 that has received the scenario execution request in S11. Thus, it is possible to identify the scenario execution device 3 to perform the process of S31.

Upon receiving the scenario execution request in S11, the scenario execution device 3 (the scenario execution unit 33) responds to the user terminal 4, which is the source of the request of S11, with the count result of S30 (the process result of S20 in the own device or the other device).

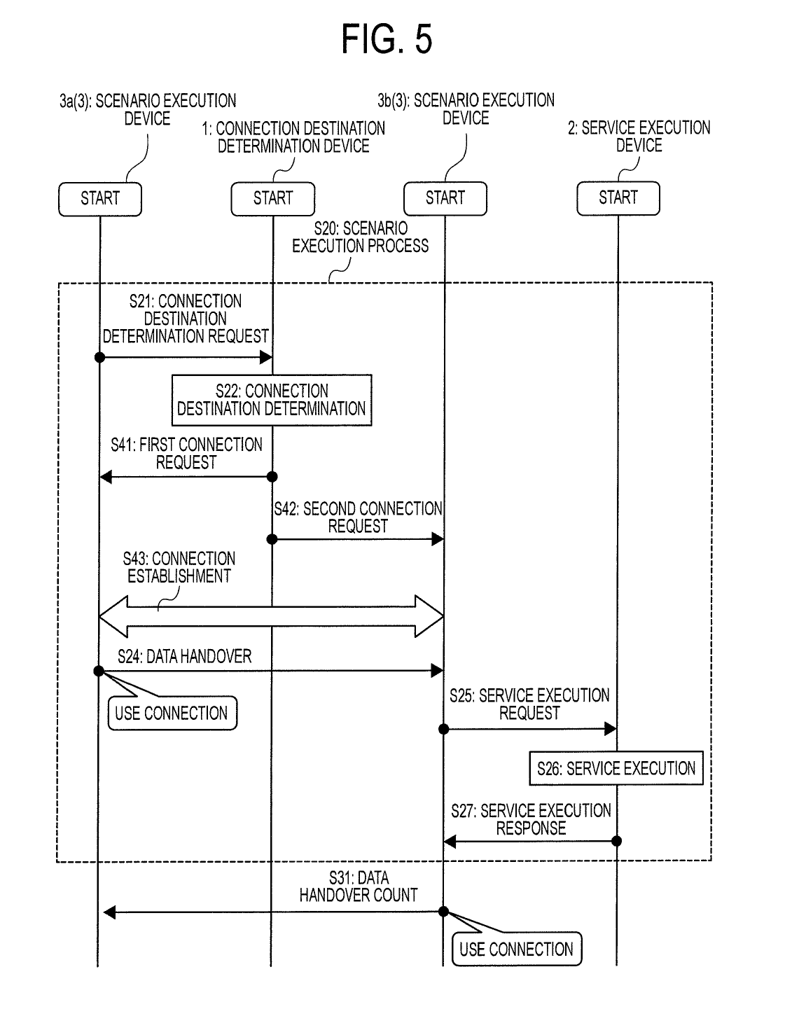

FIG. 5 is a flowchart showing a variation of the scenario execution process in the service collaboration process. In FIG. 5, S41 to S43 are newly added to S20 of FIG. 4. Note that the steps of S11 and S32, which are omitted in FIG. 5, are also executed in the variation of FIG. 5 in the same manner as in FIG. 4.

First, as the preparation of the data handover process (S24) from the scenario execution device 3a, which is the handover source, to the connection destination scenario execution device 3b (corresponding to the assigned execution device), which is the handover destination, the connection destination determination device 1 transmits an INVITE message of the Session Initiation Protocol (SIP), which is the call control process (3PCC: 3rd Party Call Control) by a third party, to the scenario execution devices 3a and 3b. In this way, the connection destination determination device 1 establishes a call connection between the scenario execution devices 3a and 3b.

More specifically, the connection destination determination device 1 transmits, as a first connection request, an INVITE message to the scenario execution device 3a (S41) which is the handover source. Then, the connection destination determination device 1 generates an INVITE message, as a second connection request, based on the response to S41 (not shown). The connection destination determination device 1 transmits the second connection request to the scenario execution device 3b which is the handover destination (S42). The two destination requests specify their connection destination devices, respectively. For example, the connection destination of the first destination request is the scenario execution device 3b.

Then, the two scenario execution devices 3 establish a connection based on the received INVITE messages (S43). The data handover (S24) and the data handover count (S31) are transmitted through the connection established in S43.

As described above, the connection destination determination device 1 connects the two scenario execution devices 3 through the call control process by the third party. This makes it possible to control the connection established by the connection destination determination device 1. For example, the connection destination determination device 1 can set the communication quality, the communication bandwidth, the protocol to be used, and the like, which are established in S43, by control messages such as the INVITE message of the connection request. Thus, it is possible to achieve flexible connection management as follows:
Increase the communication quality (such as the bandwidth) to be assigned to the connection of the client user charged.
Change the communication bandwidth according to the type of the collaboration service to be executed.

Further, the connection destination determination device 1 may provide a connection between the connection destination determination device 1 (corresponding to the assigned execution device) and the service execution device 2, as the call control process by the third party. This connection is used for the service execution request (S25) and the response thereto (S27).

FIG. 6 is a flowchart showing the details of the connection destination determination process (S22) executed by the connection destination response unit 14. In this flowchart, the connection destination service is determined according to the context (such as the authentication state of the user) that is determined when the collaboration service is executed.

First, the connection destination response unit 14 obtains the approval policy necessary for the execution of the collaboration service specified as the search key, from the policy storage unit 12 (S101). Then, the connection destination response unit 14 determines whether the user authentication state included in the connection destination determination request (S21) satisfies the approval policy (S102). If YES in S102, the process proceeds to S104. If NO in S102, the process proceeds to S103.

As S103, the connection destination response unit 14 obtains the connection destination (for approval) according to each approval type included in the authentication policy, from the authentication destination list 13. Then, the connection destination response unit 14 calls the authentication service to update the user authentication state (S103). Then, the connection destination response unit 14 determines again whether the authentication state of the user satisfies the approval policy (S102). For example, in the authentication destination list 13 of the Table 1, there are two destinations (“http://idpw1” and “http://idpw2/”) of the authentication service for the execution of “ID/PW authentication”. In this case, the connection destination “http://idpw1/” has the lower load value of the two connection destinations, and is selected as the call destination.

As S104, the connection destination response unit 14 obtains, from the service list 16, candidates for the connection destination service (for collaboration) that is necessary for the execution of the collaboration service specified as the search key.

As S105, the connection destination response unit 14 determines one connection destination according to a predetermined condition, from the candidates of S104. For example, when the predetermined condition is to “select a service with low load”, the connection destination response unit 14 selects the connection destination service with the smallest “connection destination load value” in the service list 16. It is also possible that in addition to the “connection destination load value”, the service attribution information (service fee, registered user of the service, and the like) necessary for the determination of the predetermined condition is stored in the service list 16 in advance. In this case, various predetermined conditions such as “select a service with a low service fee” and “select a service for which the user registers” can be used solely or along with other predetermined conditions (such as logical operation with AND/OR operator). Further, the predetermined condition may be to “select a service at random”.

As S106, the connection destination response unit 14 responds to the scenario execution device 3 (the connection destination request unit 31) with the connection destination determined in S103 or in S105.

The connection destination response unit 14 may respond to the scenario execution device 3 with the connection destination (for authentication) determined in S103. This allows the scenario execution device 3 to call the authentication service of the connection destination (for authentication) (first destination response unit).

The connection destination response unit 14 may respond to the scenario execution device 3 with the connection destination (for collaboration) determined in S105. This allows the scenario execution device 3 to call the authentication service of the connection destination (for collaboration) (second destination response unit).

As described above, the major feature of this embodiment is the method in which the connection destination determination device 1 determines the service to be called by the scenario execution device 3 in response to the request of S21 when the scenario is executed (the method shown in FIG. 1B), and not the method in which the service to be called by the scenario execution device 3 is directly described in the scenario (the method shown in FIG. 1A).

In this way, the proper destination service is selected in the execution of the scenario. As a result, various effects can be obtained as follows:
By determining the authentication service described in the authentication destination list 13 as the connection destination (S103), it is possible to properly perform the authentication process according to the approval policy for each service (in the policy storage unit 12). As a result, the security of the collaboration service can be improved.
By selecting the service from the service list 16 in which the connection destination for collaboration is described, based on a predetermined condition according to the service state such as the connection destination load value (S105), it is possible to improve the process throughput of the collaboration service.
Scenario designers can design the scenario without taking into account the execution progress data, the client user authentication state, and the like. As a result, the development costs can be reduced.

What is claimed is:

1. A connection destination determination device used for a service collaboration system,
wherein the service collaboration system includes:
a scenario execution device for calling a connection destination service to achieve each of a plurality of collaboration services, based on the scenario that specifies the order of the execution of the collaboration services;
a service execution device for executing the called connection destination service; and
a connection destination determination device for determining the connection destination service from the collaboration service,
wherein the connection destination determination device includes a memory unit, an approval determination unit, a first connection destination response unit, and a second connection destination response unit,
wherein the memory unit stores approval policy data showing a user authentication state for each of the collaboration services in order to allow the collaboration service to be executed, authentication destination list data showing a connection destination of authentication service to update the user authentication state, and service list data showing a connection destination of service for each of the collaboration services to execute the collaboration service;
wherein upon receiving a connection destination determination request including the collaboration service, which is a search key, and the user authentication state from the scenario execution device, the approval determination unit performs an approval determination process to determine that the user authentication state of the connection destination request is approved if the user authentication state satisfies the user authentication state corresponding to the collaboration service stored as the search key in the approval policy data,
wherein if the user authentication state is determined to be approved in the approval determination process, the first connection destination response unit obtains the connection destination of service corresponding to the collaboration service, which is the search key, from the service list data,
wherein the first connection destination response unit responds to a source of the connection destination determination request with the obtained connection destination as the connection destination service, wherein if the user authentication state is not determined to be approved in the approval determination process, the second connection destination response unit obtains the connection destination of authentication service in order to obtain the user authentication state not satisfied in the approval determination process, from the authentication destination list data, and
wherein the second connection destination response unit responds to a source of the connection destination determination request with the obtained connection destination as the connection destination service.

2. The connection destination determination device according to claim 1,
wherein the memory unit stores the connection destination of service, together with a load value of the connection destination service as the service list data,
wherein when the service list data includes a plurality of connection destinations of service corresponding to the collaboration service which is the search key, the response unit obtains the connection destination with the lowest load value of the plurality of connection destinations, and
wherein the response unit responds to the source of the connection destination determination request with the connection destination with the lowest load value of the plurality of connection destinations, as the connection destination service.

3. The connection destination determination device according to claim 2,
wherein the response unit determines whether the load value corresponding to one connection destination of the plurality of connection destinations of service is equal to or less than a predetermined threshold,
wherein if it is determined that the load value corresponding to the one connection destination is not equal to or less than the predetermined threshold, the response unit performs a query process to determine whether the load value corresponding to a connection destination other than the one connection destination of the plurality of connection destinations of service, is equal to or less than the predetermined threshold, and
wherein the response unit repeats the query process until the connection destination with the lowest load value is found.

4. The connection destination determination device according to claim 1,
wherein the response unit establishes a communication connection between the scenario execution device, which is the source of the connection destination determination request, and the service execution device for executing the connection destination service by means of a third party control of the Session Initiation Protocol (SIP), in order to prepare for the process of responding to the source of the connection destination determination request with the connection destination service.

5. The connection destination determination device according to claim 1,
wherein the memory unit stores not only the connection destination of service but also the scenario execution device assigned to call the connection destination service, as the service list data,
wherein the response unit responds to the source of the connection destination determination request with the connection destination service, together with the identification information of the scenario execution device assigned to the connection destination service to be responded to in the service list data, and
wherein when the scenario execution device receiving the response to the connection destination determination request is different from the assigned scenario execution device, the calling process of the connection destination service is handed over to the assigned scenario execution device from the scenario execution device that has received the response.

6. A service collaboration system comprising the connection destination determination device, the scenario execution device, and the service execution device according to claim 1.

7. The service collaboration system according to claim 6,
wherein a plurality of the service execution devices are provided in the service collaboration system, and
wherein each of the service execution devices executes the same connection destination service.

8. A method for determining connection destinations by a service collaboration system,
wherein the service collaboration system includes:
a scenario execution device for calling a connection destination service to achieve each of a plurality of collaboration services, based on the scenario that specifies the order of the execution of the collaboration services;
a service execution device for executing the called connection destination service; and
a connection destination determination device for determining the connection destination service from the collaboration service,
wherein memory means of the connection destination determination device stores approval policy data showing a user authentication state for each of the collaboration services in order to allow the collaboration service to be executed, authentication destination list data showing a connection destination of authentication service to update the user authentication state, and service list data showing a connection destination of service for each of the collaboration services to execute the particular collaboration service, and
wherein a control unit of the connection destination determination device includes the steps of:
receiving a connection destination determination request including the collaboration service, which is a search key, and the user authentication state from the scenario execution device;
performing an approval determination process to determine that the user authentication state of the connection destination request is approved if the user authentication state satisfies the user authentication state corresponding to the collaboration service stored as the search key in the approval policy data;
if the user authentication state is determined to be approved in the approval determination process, obtaining the connection destination of service corresponding to the collaboration service, which is the search key, from the service list data, and responding to a source of the connection destination determination request with the obtained connection destination as the connection destination service;
if the user authentication state is not determined to be approved in the approval determination process, obtaining the connection destination of authentication service in order to obtain the user authentication state not satisfied in the approval determination process, from the authentication destination list data, and responding to a source of the connection destination determination request with the obtained connection destination as the connection destination service.

9. The connection destination determination method according to claim 8,
wherein the memory means of the connection destination determination device stores the connection destination of service, together with a load value of the connection destination service as the service list data, and
wherein when the service list data includes a plurality of connection destinations of service corresponding to the collaboration service which is the search key, the control unit of the connection destination determination device responds to the source of the connection destination determination request with the connection destination with the lowest load value of the plurality of connection destinations, as the connection destination service.

10. The connection destination determination method according to claim 9,
wherein the control unit of the connection destination determination unit determines whether the load value corresponding to one connection destination of the plurality of connection destinations of service is equal to or less than a predetermined threshold,
wherein if it is determined that the load value corresponding to the one connection destination is not equal to or less than the predetermined threshold, the control unit performs a query process to determine whether the load value corresponding to a connection destination other than the one connection destination of the plurality of connection destinations of service, is equal to or less than the predetermined threshold, and
wherein the control unit repeats the query process until the connection destination with the lowest load value is found.

11. The connection destination determination method according to claim 8,
wherein the control unit of the connection destination determination device establishes a communication connection between the scenario execution device, which is the source of the connection destination determination request, and the service execution device for executing the connection destination service by means of a third party control of the Session Initiation Protocol (SIP), in order to prepare for the process of responding to the source of the connection destination determination request with the connection destination service.

12. The connection destination determination method according to claim 8,
wherein the memory means of the connection destination determination device stores not only the connection destination of service but also the scenario execution device assigned to call the connection destination service, as the service list data,
wherein the control unit of the connection destination determination device responds to the source of the connection destination determination request with the connection destination service, together with the identification information of the scenario execution device assigned to the connection destination service to be responded to in the service list data, and
wherein when the scenario execution device receiving the response to the connection destination determination request is different from the assigned scenario execution device, the calling process of the connection destination service is handed over to the assigned scenario execution device from the scenario execution device that has received the response.
